(19) United States
(12) Patent Application Publication
(10) Pub. No.: US 2008/0200111 A1
(43) Pub. Date: Aug. 21, 2008

(54) Sealed ventilation duct

(76) Inventor: Herbert G. Gibson, Mahtomedi, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 12/069,017

(22) Filed: Feb. 6, 2008

Related U.S. Application Data
(60) Provisional application No. 60/888,352, filed on Feb. 6, 2007.

(51) Int. Cl. F24F 7/06; F16L 9/00; B21D 39/04

(52) U.S. Cl. 454/251; 138/163; 29/428

(57) ABSTRACT

A sealed ventilation duct for an HVAC system includes a sheet of flexible material incorporating an insulated bonding sealer and folded so as to be self-locking. The insulated bonding sealer adheres the opposing longitudinal edges together to maintain the desired shape of the duct and improves the energy efficiency of the HVAC by reducing the overall thermal conductivity of the duct network. The insulated bonding sealer is applied proximal an edge of the sheet of flexible material which is folded so as form a duct. A method of manufacturing a duct is further included.

### RELATED APPLICATIONS

The present application claims the benefit of U.S. Provisional Application No. 60/888,352, entitled VENTILATION DUCT, filed Feb. 6, 2007, which is incorporated herein by reference in its entirety.

### FIELD OF THE INVENTION

The present invention relates generally to ventilation ducts and, more specifically, to sealed ducts having improve energy-efficiency qualities.

### BACKGROUND OF THE INVENTION

Heating, ventilation, and air-conditioning (HVAC) systems are used extensively in the climate control of buildings, especially large industrial and office buildings. Generally, HVAC systems provide thermal comfort and enhance indoor air quality. Relying upon the basic principles of thermodynamics, fluid mechanics, and heat transfer, HVAC systems can provide ventilation, reduce the infiltration of undesirable air, and support desired pressure relationships between selected spaces. HVAC systems can thereby help regulate desired temperature and humidity levels and maintain healthy and safe conditions in controlled environments.

Many HVAC systems achieve a climate-controlled environment by creating and directing airflow consisting of regulated air. In a forced-air system, an air-handling unit typically generates the flow of regulated (and sometimes unregulated) air, while a duct network directs the flow of regulated air and provides a physical barrier. The air-handling unit is often also responsible for controlling certain qualities of the delivered air. For example, the air-handling unit may heat, cool, filter, or otherwise regulate or modify some characteristic of the air. It is common for HVAC systems to perform multiple functions by using forced air to selectively ventilate, heat, and air-condition a controlled environment.

To function properly, HVAC systems typically incorporate ducts to deliver or remove supply air, return air, and exhaust air. These ducts provide an enclosed conduit for guiding the air flow generated by the air-handling unit. Air that has been regulated by the air-handling unit can thereby be routed to various locations while providing a barrier against the mixing of regulated and unregulated air. In this manner, HVAC systems can supply regulated air to a certain space through outlet vents, or diffusers, and remove unregulated, or mixed, air at other spaces through inlet vents, or grilles.

Ventilation ducts are well known in the HVAC industry. For example, U.S. Pub. No. 2008/0017269 A1 to Gudenburr, et al., entitled “Self Locking Sheet Metal Duct with a Sealant and Method for Manufacturing the Duct with a Sealant and Installing the Duct with a Sealant,” discloses a self-locking duct, U.S. Pub. No. 2006/0263032 A1 to Choi, et al., entitled “Combined Illumination and Ventilation Duct,” discloses a ventilation duct that incorporates an optical pipe, U.S. Pub. No. 2006/0213498 A1 to Sellwood, entitled “Ventilation Duct,” discloses a seamless ventilation duct that can be collapsed for transportation or storage, U.S. Pat. No. 7,066,974 to Andersson, entitled “Device in Ventilation Ducts Provided with Adjustable Filter Means,” discloses a ventilation duct with a filter bag, U.S. Pat. No. 6,629,706 to Tigerfeldt, entitled Ventilation Duct Construction and Method, discloses a ventilation duct that is fire-retardant and sound-absorbing, and U.S. Pat. No. 5,094,273 to Eagleton, entitled “Ventilation Ducting,” discloses a ventilation duct with a reduced profile or width, the disclosures of which are hereby incorporated herein in their entireties.

A drawback of current ducts used in HVAC systems is energy inefficiency. Specifically, most ducts are fabricated by shaping a sheet of material, such as rolled or corrugated steel, into a desired form. Once the duct has been formed, the edges of the shaped sheet of material are formed by bending into cooperative joints and are normally joined. By joining the edges, the desired shape of the duct can be maintained and the longitudinal joint, or seam, of the duct can be closed. The existence of this seam, however, can result in an undesirable mixing of regulated and unregulated air. For example, in a heating system, the seam can contribute to energy inefficiency by permitting heated air to escape from the duct while permitting relatively cool air to enter the duct. Similarly, in an air-conditioning system, the seam can contribute to energy inefficiency by permitting cooled air to escape from the duct while permitting relatively warm air to enter the duct. It is estimated that energy loss of as much as twenty percent can occur due to leakage through poorly or unsealed longitudinal joints. In HVAC systems which rely upon ducts to provide a conduit for regulated air over relatively large distances, therefore, energy inefficiency due to insufficient sealing of longitudinal joints can result in a significant increase in costs.

Another drawback of exiting ducts is the difficulty with which they can be sealed. In particular, it is becoming increasingly common for municipalities and other governmental agencies to modify building codes to require the longitudinal joints of ducts used in HVAC systems to be sealed. The use of sealant material to meet these standards, however, can often detract from the aesthetic appearance of the ducts and increase overall inefficiency by impeded air flow. For example, using a liquid sealant can result in sealant seeping out through the seam created when the duct is formed. In addition, the integration of a sealant-application step into the duct-formation process can be extremely costly and result in slower production times and decreased output.

Yet another drawback of existing ducts is that even if the longitudinal joints can be properly sealed, achieving such a seal often generally occurs at the expense of durability. Specifically, to accommodate the sealant, modifications to the process of duct formation as well as to the design of the duct may be necessary. Such modifications commonly detract from the ability of the duct to maintain its form or a strong longitudinal joint. As a result, ducts having sealed longitudinal joints tend to be less sturdy. Slight disruptions in duct segments can result in more frequent damage, thereby increasing the costs associated with maintenance through expensive and time-consuming repair or replacement procedures.

Therefore, there is a need in the HVAC industry for an apparatus and method of making an apparatus that addresses the aforementioned drawbacks.

### SUMMARY OF THE INVENTION

Embodiments of the present invention address the above-mentioned needs by providing an apparatus, methods for providing an apparatus, and a system for directing airflow through a duct network. Although embodiments of the present invention may be used for any number of purposes, the apparatus is generally integrated into a duct network used to direct regulated and unregulated air as part of an HVAC system.

In an embodiment, a duct according to the present invention comprises a flexible sheet of material and an insulated bonding sealer. The flexible sheet of material has a main portion, a first locking portion, and a second locking portion. The first and second locking portions are resiliently deformable so that the first locking portion selectively receives the second locking portion to form a longitudinal seam. The insulated bonding sealer is affixed to the flexible sheet of material intermediate the first and second locking portions and substantially seals the seam.

In another embodiment, an HVAC system according to the present invention comprises an air-handling unit and a duct network. The air-handling unit creates airflow. The duct network is in communication with the air-handling unit for routing airflow and has at least one duct. The duct comprises a flexible sheet of material having a main portion, a first locking portion, and a second locking portion. The first and second locking portions are resiliently deformable so that the first locking portion selectively receives the second locking portion to form a longitudinal seam. The insulated bonding sealer is affixed to the flexible sheet of material intermediate the first and second locking portions and substantially seals the seam.

In other embodiments, the first locking portion may define a gap adapted to receive the insulated bonding sealer. The gap may be further adapted to receive a second insulated bonding sealer, the second locking portion being positioned between the respective bonding sealers. The insulated bonding sealer may have a thickness in the range of approximately 0.001 inches (in.) to approximately 0.5 in., or approximately 0.010 in. The insulated bonding sealer may have a density in the range of approximately 10 pounds per cubic foot (lb/ft³) to approximately 100 lb/ft³, or approximately 50 lb/ft³. The insulated bonding sealer may have a thermal conductivity in the range of approximately 0.03 BTU-feet per square foot per hour per degree Fahrenheit (BTU-ft/ft² Hr ° F.) to approximately 1.0 BTU-ft/ft² Hr ° F., or approximately 0.092 BTU-ft/ft² Hr ° F. The insulated bonding sealer may have a dynamic shear to stainless steel in the range of approximately 10 pounds per square inch (lb/in²) to approximately 250 lb/in², or approximately 80 lb/in². The insulated bonding sealer may also resist the growth of mold and form a substantially permanent seal.

In another embodiment, a method of manufacturing a duct from a sheet of flexible material having first and second parallel longitudinal edges defining the length of the duct according to an embodiment of the present invention comprises the steps of attaching an insulated bonding sealer proximal the first longitudinal edge, forming a first locking portion from the sheet material proximal the first longitudinal edge, forming a seconding locking portion from the sheet material proximal the second longitudinal edge, shaping the sheet material into a self-locking hollow enclosure, attaching the insulated bonding sealer proximal the first longitudinal edge, and engaging the first and second locking portions. The first and second locking portions form a longitudinal seam substantially sealed by the insulated bonding sealer.

In other embodiments, the method may further comprise the step of attaching a second insulated bonding sealer proximal the second longitudinal edge. The self-locking hollow enclosure may be substantially tubular. The insulated bonding sealer may include an adhesive layer covered by a removable tape liner. The step of engaging the first and second locking portions may include the step of removing the tape liner from the insulated bonding sealer to expose the adhesive layer.

### BRIEF DESCRIPTION OF THE FIGURES

The embodiments of the present invention may be more completely understood in consideration of the following detailed description of various embodiments in connection with the accompanying drawings, in which:

FIG. 1 is diagram of an HVAC system according to an embodiment of the present invention;

FIG. 2 is an illustration of a portion of an HVAC system according to an embodiment of the present invention;

FIG. 3 is an illustration of a portion of an HVAC with ducts depicted in phantom according to an embodiment of the present invention;

FIG. 4 is an illustration of a perimeter duct network according to an embodiment of the present invention;

FIG. 5 is an illustration of a perspective view of ducts according to an embodiment of the present invention;

FIG. 6A is a perspective view of a duct according to an embodiment of the present invention;

FIG. 6B is a perspective view of a duct according to an embodiment of the present invention;

FIG. 7 is a cross-sectional elevation view of an open longitudinal joint of a duct according to an embodiment of the present invention;

FIG. 8 is a cross-sectional elevation view of an open longitudinal joint of a duct according to an embodiment of the present invention;

FIG. 9 is a cross-sectional elevation view of an open longitudinal joint of a duct according to an embodiment of the present invention;

FIG. 10 is a cross-sectional elevation view of a duct with a closed longitudinal joint according to an embodiment of the present invention;

FIG. 11 is a cross-sectional elevation view of a duct with a closed longitudinal joint according to an embodiment of the present invention;

FIG. 12 is a cross-sectional elevation view of a duct with a closed longitudinal joint according to an embodiment of the present invention;

FIG. 13 is a perspective view of a dispenser used to apply a sealing adhesive to a sheet of material in forming a duct according to an embodiment of the present invention;

FIG. 14 is a perspective view an applicator used to apply an insulated bonding strip to a sheet of material used to form a duct according an embodiment of the present invention;

FIG. 15 is a perspective view an applicator used to apply an insulated bonding sealer to a sheet of material used to form a duct according an embodiment of the present invention;

FIG. 16 is a perspective view an applicator used to apply an insulated bonding sealer to a sheet of material used to form a duct according an embodiment of the present invention;

FIG. 17 is a perspective view of a sheet of material used to form a duct with an insulated bonding sealer applied to the sheet of material;

FIG. 18 is a perspective view of a removable tape liner being removed from an insulated bonding sealer applied to a duct according to an embodiment of the present invention; and

FIG. 19 is a perspective view of a removable tape liner being removed from an insulated bonding sealer applied to a duct according to an embodiment of the present invention.

While the present invention is amendable to various modifications and alternative forms, specifics thereof have been shown by way of example in the drawings and will be described in detail. It should be understood, however, that the intention is not to limit the present invention to the particular embodiments described. On the contrary, the intention is to cover all modifications, equivalents, and alternatives falling within the spirit and scope of the present invention.

### DETAILED DESCRIPTION OF THE INVENTION

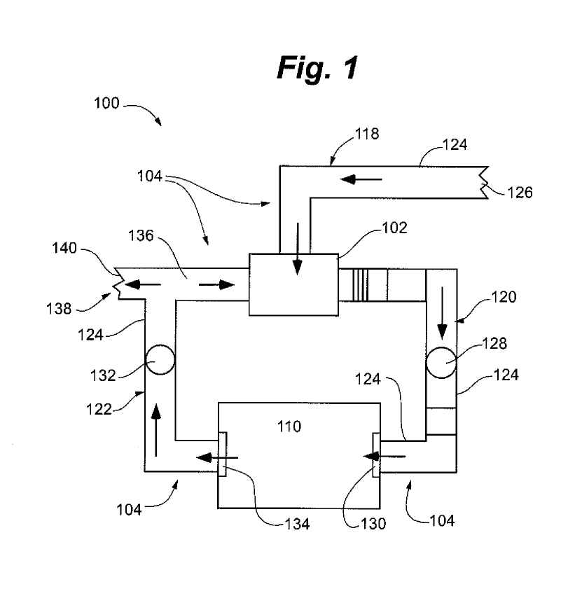

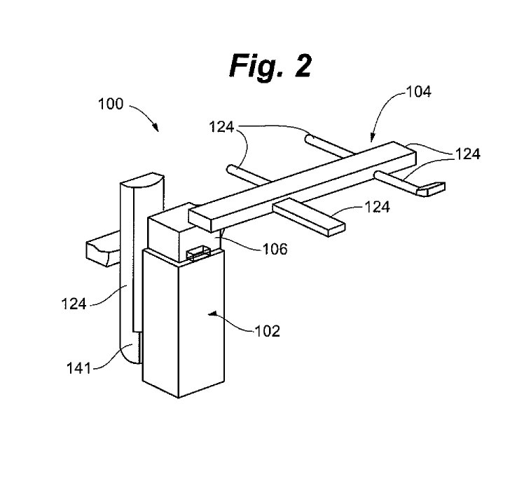

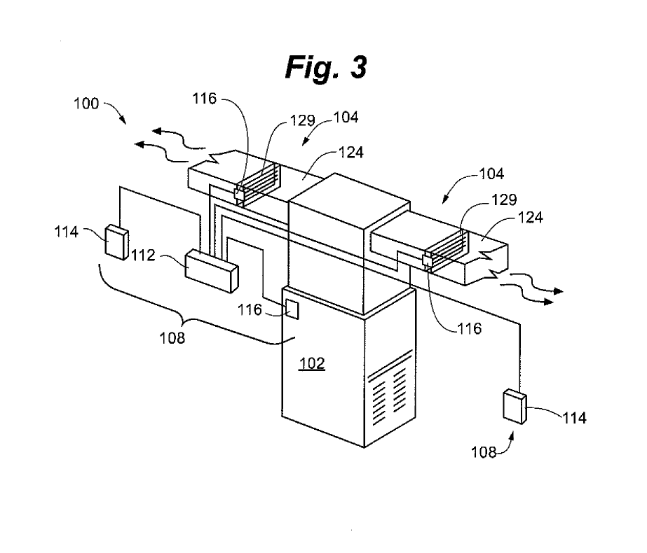

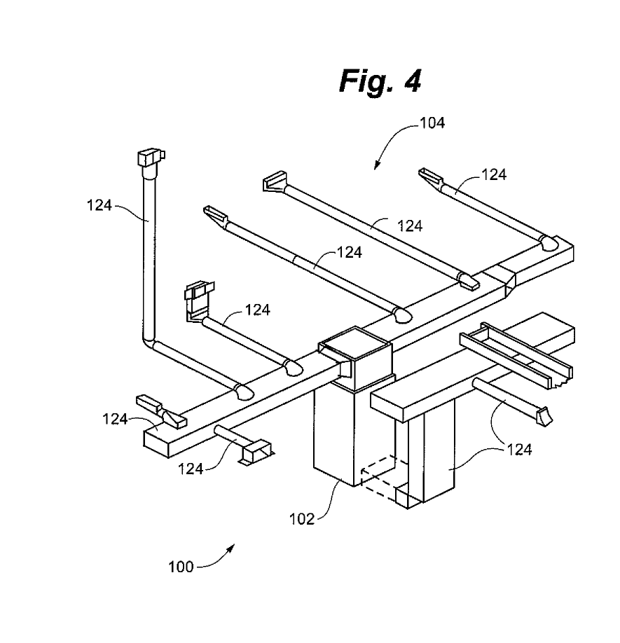

Referring to FIG. 1, an HVAC system is depicted generally with reference numeral 100. HVAC system 100 generally includes air-handling unit 102 and duct network 104. HVAC system 100 may also include a number of other features, such as, for example, plenum chamber 106 and control system 108, as depicted in FIGS. 1-3. Although HVAC system 100 can be used for any number of purposes, HVAC system 100 is generally used regulate the air entering and exiting room 110, such as, for example, through localized climate control.

Air-handling unit 102 is any type of unit capable of generating an airflow within duct network 104 (the various directions of which are depicted with large arrows in FIGS. 1-3). In an example embodiment, air-handling unit 102 receives unregulated air, modifies the unregulated air into regulated air, and urges the regulated air through duct network 104. For example, air-handling unit 102 may include a humidifier or dehumidifier so as to regulate the moisture content of the regulated airflow. Air-handling unit 102 may also include a heating unit so as to heat the airflow entering duct network 104. Similarly, air-handling unit 102 may include a cooling unit so as to cool the airflow entering duct network. Additional functions, such as, for example, filtering, de-ionizing, other otherwise purifying air, can also be performed by air-handling unit 102. One skilled in the art will readily recognize that any number of air-handling units 102 that perform a combination of these functions can be incorporated into HVAC system 100 without departing from the spirit or scope of the present invention.

Control system 108 may include control panel 112 and thermostat 114. Control system 108 is operably connected to air-handling unit 102 and duct network 104, such as, for example, by system actuators 116. Generally, control system 108 allows for manual or automatic control of any number of parameters such as, for example, temperature, pressure, humidity, flow rate, and particle composition, through electrical or mechanical means.

Duct network 104 may be made up of various sub-networks, such as, for example, intake network 118, supply network 120, and return network 122. Intake, supply, and return networks 118, 120, 122 generally include interconnected ducts 124 arranged to deliver regulated air from air-handling unit 102 to room 110 and deliver unregulated air to air-handling unit 102. Intake network 118 may also include air intake damper 126. Supply network may also include supply fan 128, supply damper 129, and supply diffuser 130. Supply diffuser 130 provides an exit port for regulated airflow from supply network 120 into room 110. Return network 122 may also include return fan 132, return grille 134, return damper 136, exhaust outlet 138, and exhaust damper 140. Return grille 134 provides an entry port for unregulated air from room 110 into return network 122. One skilled in the art will readily recognize that intake network 118, supply network 120, and return network 122 may include any number of additional features that assist in the regulation and delivery of regulated air through duct network 104, such as, for example, filter 141.

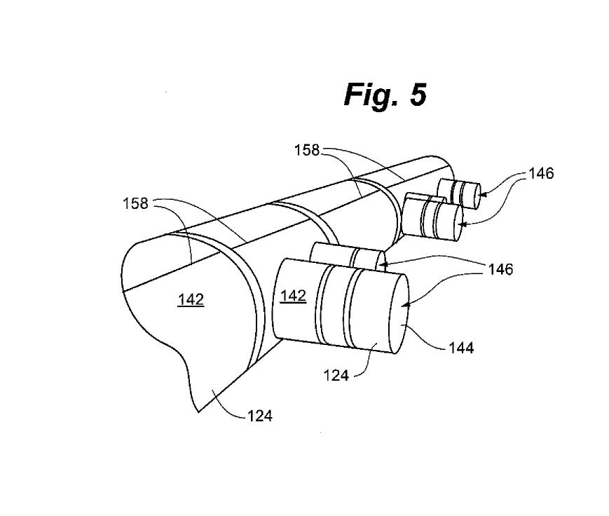

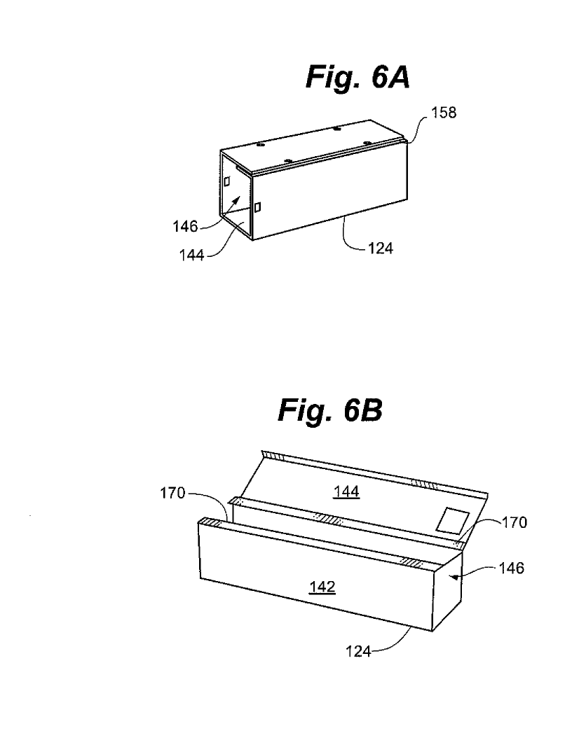

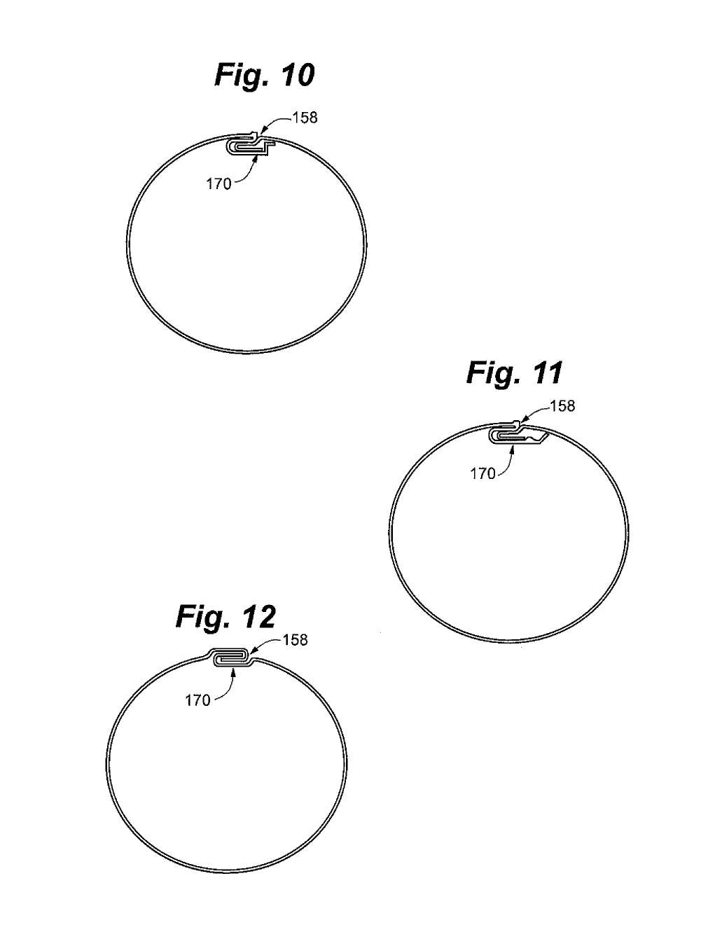

Each duct 124 has outer surface 142 and inner surface 144 and defines channel 146, as depicted in FIGS. 5-6 and 10-12. Ducts 104 generally provide a conduit for the flow of air, both regulated and unregulated, within duct network 104 through channel 146. Ducts 124 can be any number of shapes and sizes and made from any number of materials. For example, ducts 124 can define channel 146 that is substantially circular, as depicted in FIGS. 10-12. Ducts 124 can also define channel 146 that is substantially square-like, as depicted in FIG. 6.

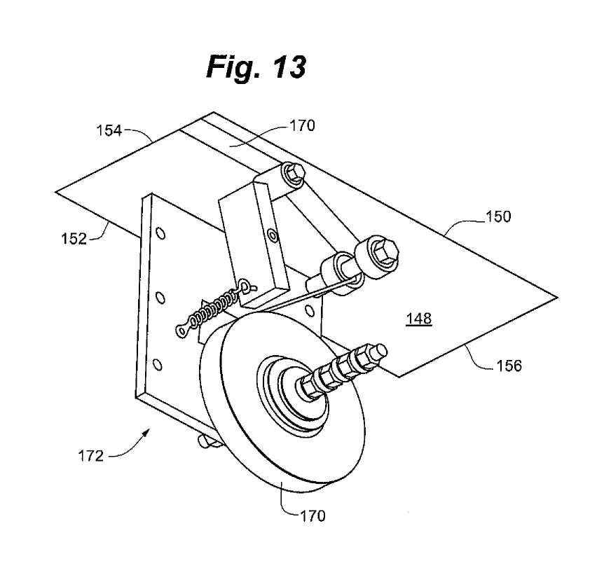

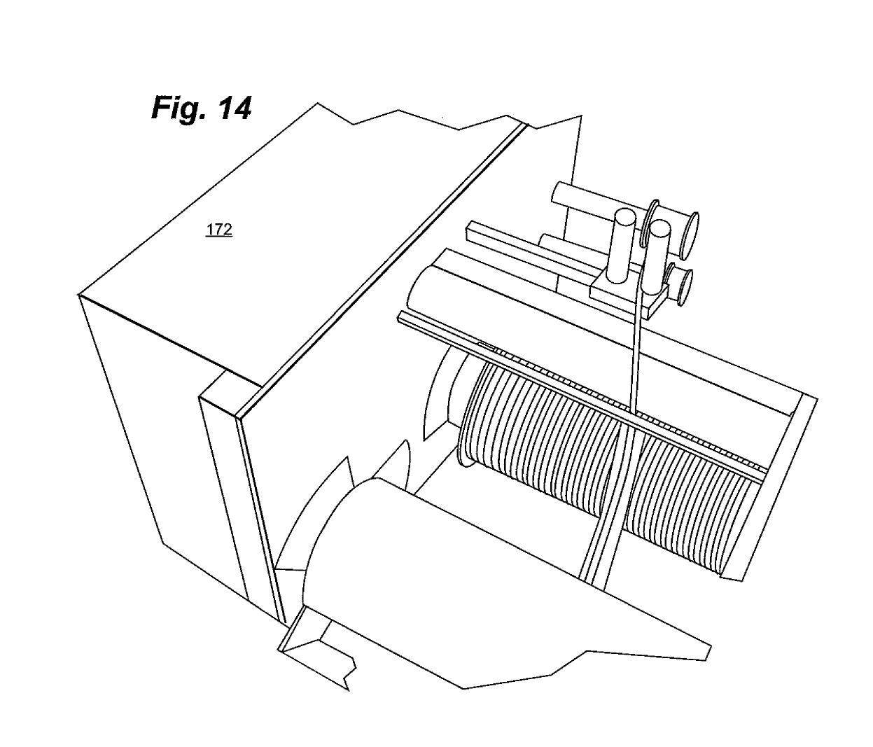

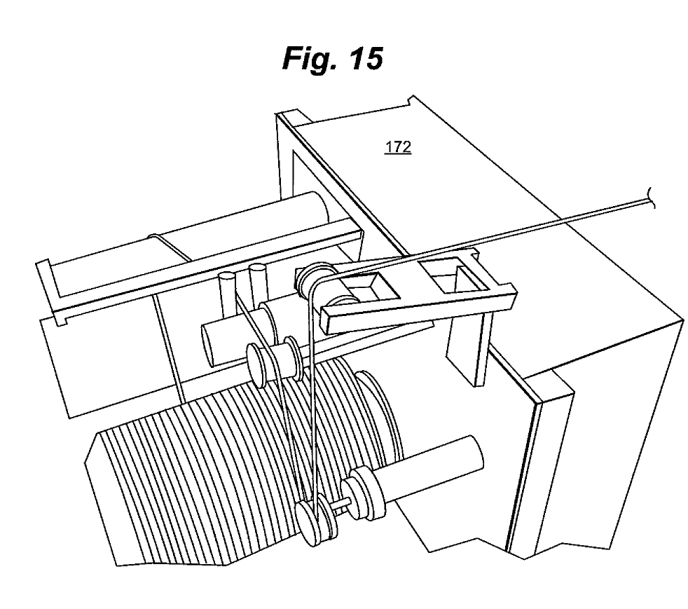

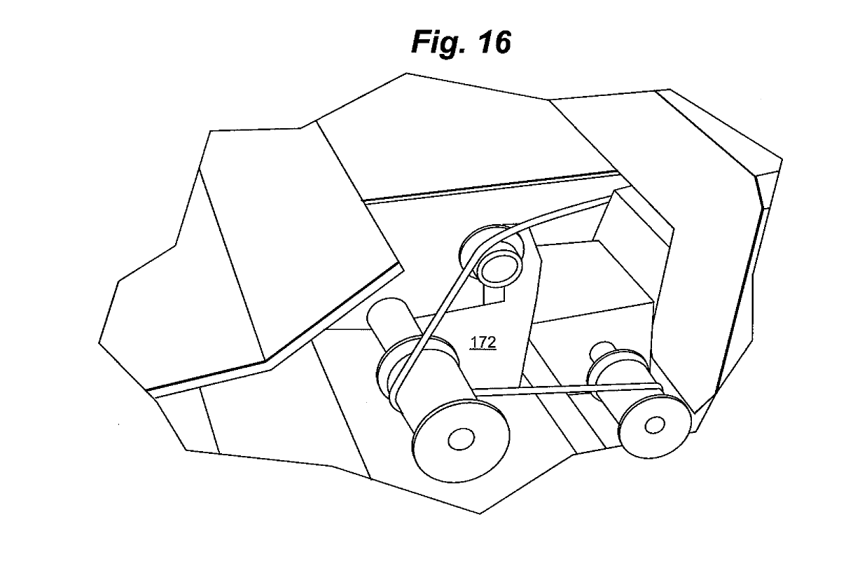

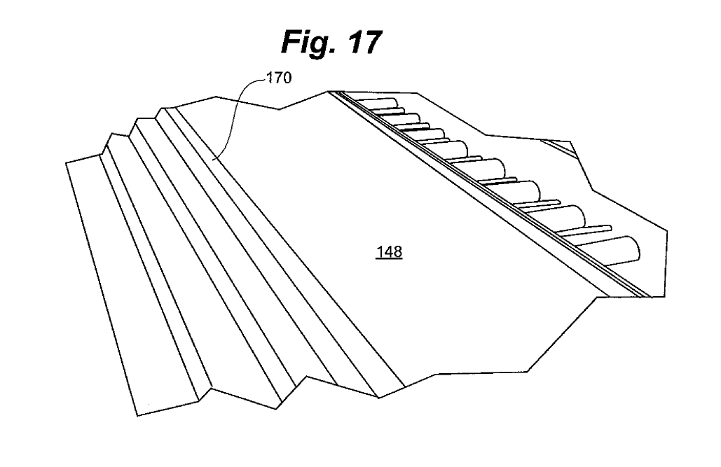

Ducts 124 can be made in any number of ways. For example, ducts 124 can be molded or extruded using a suitable material. Ducts 124 can also be made from a sheet of material 148 and subsequently formed into a desired shape. As depicted in FIG. 13, a sheet of material 148 defines longitudinal edges 150, 152 and lateral edges 154, 156. When a sheet of material 148 is folded into duct 124, longitudinal edges 150, 152 can be coupled. When coupled, longitudinal edges 150, 152 form seam 158 running the length of duct 124. Material 148 may be any number of materials capable of being shaped into duct 124 and providing an enclosure for airflow. For example, the sheet of material 148 can be rolled steel, rolled aluminum, or any number of different polymers or combinations thereof.

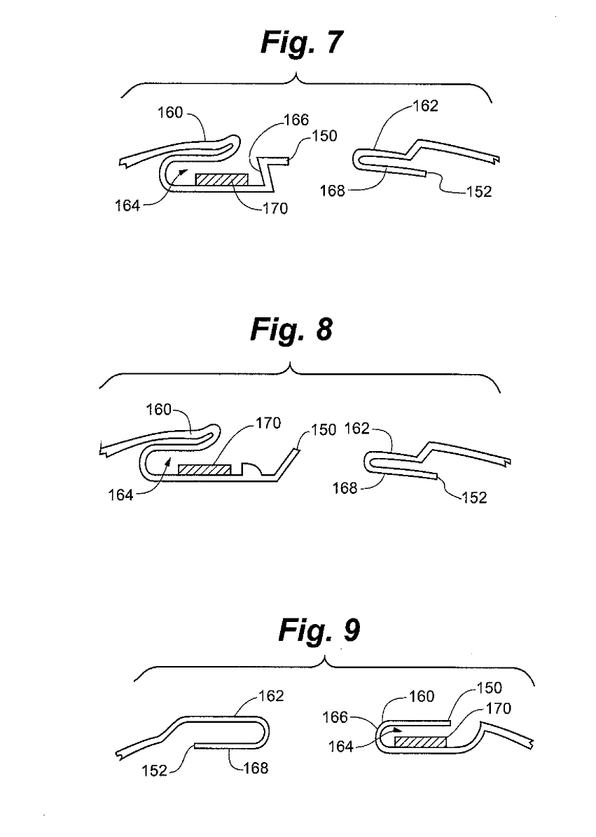

In an embodiment, longitudinal edges 150, 152 are folded, molded, or otherwise adapted so as to be interlocking, as depicted in FIGS. 7-9. When folded, for example, the area of material 148 near longitudinal edge 150 can form receiver 160 and the area of material 148 near longitudinal edge 152 can form engager 162. In an example embodiment, receiver 160 defines gap 164 adapted to receive engager 162. Examples of configurations of receiver 160 and engager 162 include the snaplock, buttonlock, and hammerlock.

Generally, the inherent resiliency of a sheet of material 148 urges receiver 160 and engager 162 apart from each other. As a result, longitudinal edges 150, 152 can be adapted so that the resiliency of a sheet of material 148 causes duct 124 to remain closed. For example, receiver 160 may present barrier 166 configured to prevent opposing protrusion 168 of engager 162 from becoming disengaged. Other embodiments are also possible, such as the hinged square duct 124 depicted in FIGS. 6A-6B.

To enhance the permanency of the interlocking fit between receiver 160 and engager 162 and to increase the energy efficiency of duct 124, a sealant can be applied to duct 124. In an example embodiment, insulated bonding sealer 170 is applied to duct 124. Insulated bonding sealer 170 generally includes an adhesive carrier made from a viscoelastic acrylic foam having energy absorbing and stress relaxing properties. Insulated bonding sealer 170 is generally coated on one or both sides with an adhesive and covered by with removable tape liner 171. Various features of insulated bonding sealer 170 can include adhesion to heated or cooled metallic or polymeric materials, conformability, high tensile strength, high shear and peel adhesion, resistance to plasticizer migration. In an example embodiment, insulated bonding sealer 170 is very-high bond tape, such as, for example, VHB™ Tape manufactured by 3M Corporation of St. Paul, Minn.

Insulated bonding sealer 170 can have a thickness in the range of approximately 0.001 inches (in.) to approximately 0.5 in. In an example embodiment, insulated bonding sealer 170 has a thickness of approximately 0.010 in. Insulated bonding sealer 170 can have a density in the range of approximately 10 pounds per cubic foot (lb/ft³) to approximately 100 lb/ft³. In an example embodiment, insulated bonding sealer 170 has a density of approximately 50 lb/ft³. Insulated bonding sealer 170 can have a thermal conductivity in the range of approximately 0.03 BTU-feet per square foot per hour per degree Fahrenheit (BTU-ft/ft² Hr ° F.) to approximately 1.0 BTU-ft/ft² Hr ° F. In an example embodiment, insulated bonding sealer 170 has a thermal conductivity of approximately 0.092 BTU-ft/ft² Hr ° F. Properties of insulated bonding sealer 170 can also include a dynamic shear to stainless steel in the range of approximately 10 pounds per square inch (lb/in²) to approximately 250 lb/in². In an example embodiment, a property of insulated bonding sealer 170 includes dynamic shear to stainless steel of approximately 80 lb/in². In yet another example embodiment of the present invention, insulated bonding sealer 170 resists the growth of mold. In a further embodiment of the present invention, insulated bonding sealer 170 forms a substantially permanent seal. One skilled in the art will readily recognize that any number of different types of insulated bonding sealers 170 can be used to seal seam 158 without departing from the spirit or scope of the present invention.

Due to the strong binding capabilities of insulated bonding sealer 170, use of insulated bonding sealer 170 to permanently seal seam 158 can pose a number of difficulties. In particular, the folded configuration of receiver 160 can inhibit proper application of insulated bonding sealer 170 within gap 164. Insulated bonding sealer 170 can also harm individuals coming into contact with its highly adhesive surface. Therefore, in an example embodiment, insulated bonding sealer 170 is applied to a sheet of material 148 before the sheet of material 148 is formed into duct 148.

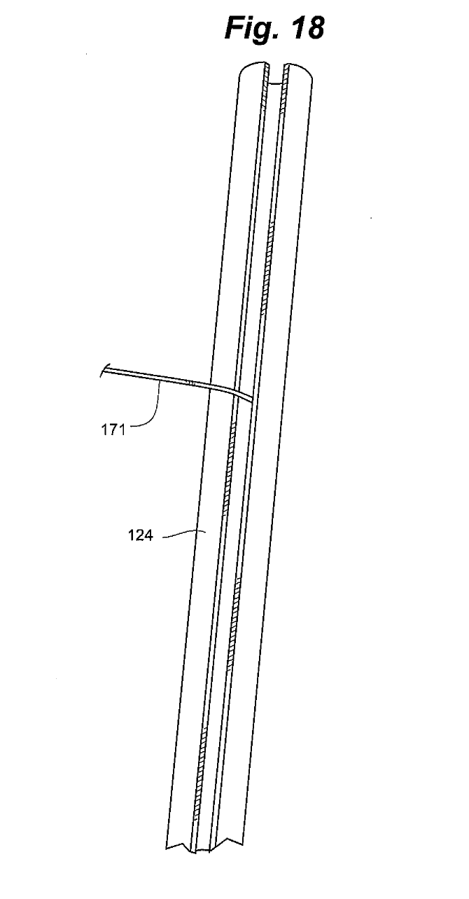

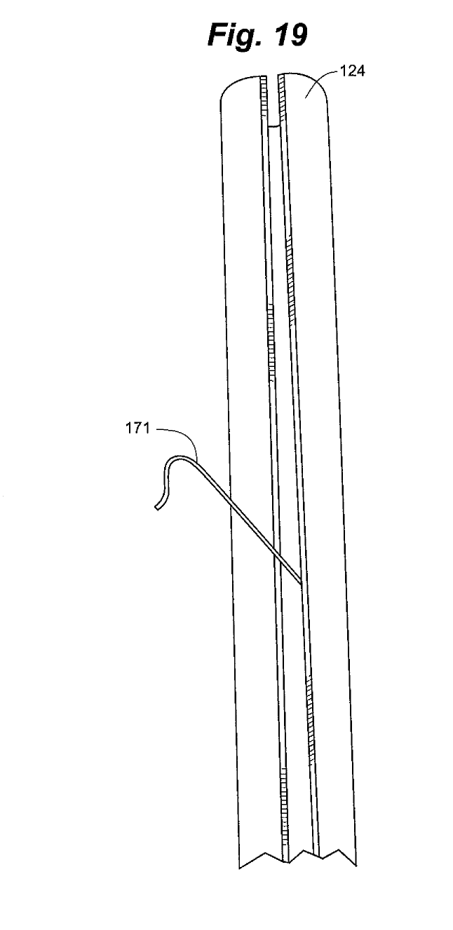

Referring to FIGS. 13 and 18-19 applicator 172 can be used to apply insulated bonding sealer 170 proximal longitudinal edge 150 or 152. Applicator 172 or multiple applicators 172 can also be used to apply multiple insulated bonding sealers 170 to each of proximal edges 150, 152. In an example embodiment, insulated bonding sealer 170 is applied to a sheet of material 148 such that after a sheet of material 148 is folded, insulated bonding sealer 170 occupies gap 164. At such time it is desired that duct 148 be installed, removable tape liner 171 can be removed from insulated bonding sealer 170 such that an adhesive layer is exposed as depicted in FIGS. 18-19. With this adhesive layer exposed, engager 162 can be coupled to receiver 160 such that one side of insulated bonding sealer 170 is affixed to receiver 160, while the other side of insulated bonding sealer 170 is affixed to engager 162, as depicted in FIGS. 10-12.

In an alternative embodiment, insulated bonding sealer 170 is applied to a sheet of material 148 such that after a sheet of material 148 is folded, insulated bonding sealer 170 is first affixed to engager 162. At such time it is desired that duct 148 be installed, removable tape liner 171 can be removed from insulated bonding sealer 170 such that an adhesive layer is exposed, as depicted in FIGS. 18-19. With the adhesive layer exposed, engager 162 can then be inserted into gap 164 and the other side of insulated bonding sealer 170 affixed to receiver 160. Although FIG. 13 depicts the application of a single insulated bonding sealer 170, multiple insulated bonding sealers 170 can be applied without departing from the spirit or scope of the present invention.

What is claimed is:

1. A duct comprising:
a sheet of flexible material having a main portion, a first locking portion, and a second locking portion, the first and second locking portions being resiliently deformable so that the first locking portion selectively receives the second locking portion to form a longitudinal seam;
an insulated bonding sealer affixed to the flexible a sheet of material intermediate the first and second locking portions; and
wherein the insulated bonding sealer substantially seals the seam upon the first locking portion selectively receiving the second locking portion.

2. The duct of claim 1, wherein the first locking portion defines a gap adapted to receive the insulated bonding sealer.

3. The duct of claim 2, wherein the gap is further adapted to receive a second insulated bonding sealer, the second locking portion being positioned between the respective bonding sealers.

4. The duct of claim 1, wherein the insulated bonding sealer has a thickness in the range of approximately 0.001 in. to approximately 0.5 in.

5. The duct of claim 4, where the insulated bonding sealer has a thickness of approximately 0.010 in.

6. The duct of claim 1, wherein the insulated bonding sealer has a density in the range of approximately 10 lb/ft³ to approximately 100 lb/ft³.

7. The duct of claim 6, wherein the insulated bonding sealer has a density of approximately 50 lb/ft³.

8. The duct of claim 1, wherein the insulated bonding sealer has a thermal conductivity in the range of approximately 0.03 BTU-ft/ft² Hr ° F. to approximately 1.0 BTU-ft/ft² Hr ° F.

9. The duct of claim 8, wherein the insulated bonding sealer has a thermal conductivity of approximately 0.092 BTU-ft/ft² Hr ° F.

10. The duct of claim 1, wherein the insulated bonding sealer has a dynamic shear to stainless steel in the range of approximately 10 lb/in² to approximately 250 lb/in².

11. The duct of claim 10, wherein the insulated bonding sealer has a dynamic shear of approximately 80 lb/in².

12. The duct of claim 1, wherein the insulated bonding sealer resists mold growth.

13. The duct of claim 1, wherein the first and second locking portions form a snaplock, buttonlock, or hammerlock when attached to each other.

14. An HVAC system comprising:
an air-handling unit for creating an airflow; and
a duct network in communication with the air-handling unit for routing the airflow, the duct network having at least one duct, the duct comprising:
a sheet of flexible material having a main portion, a first locking portion, and a second locking portion, the first and second locking portions being resiliently deformable so that the first locking portion selectively receives the second locking portion to form a longitudinal seam;
an insulated bonding sealer affixed to the flexible a sheet of material intermediate the first and second locking portions; and
wherein the insulated bonding sealer substantially seals the seam.

15. The duct of claim 14, wherein the first locking portion defines a gap adapted to receive the insulated bonding sealer.

16. The duct of claim 15, wherein the gap is further adapted to receive a second insulated bonding sealer, the second locking portion being positioned between the respective bonding sealers.

17. The duct of claim 14, wherein the insulated bonding sealer has a thickness in the range of approximately b 0.001 in. to approximately 0.5 in.

18. The duct of claim 17, where the insulated bonding sealer has a thickness of approximately 0.010 in.

19. The duct of claim 14, wherein the insulated bonding sealer has a density in the range of approximately 10 lb/ft³ to approximately 100 lb/ft³.

20. The duct of claim 19, wherein the insulated bonding sealer has a density of approximately 50 lb/ft³.

21. The duct of claim 14, wherein the insulated bonding sealer has a thermal conductivity in the range of approximately 0.03 BTU-ft/ft² Hr ° F. to approximately 1.0 BTU-ft/ft² Hr ° F.

22. The duct of claim 21, wherein the insulated bonding sealer has a thermal conductivity of approximately 0.092 BTU-ft/ft² Hr ° F.

23. The duct of claim 14, wherein the insulated bonding sealer has a dynamic shear to stainless steel in the range of approximately 10 lb/in² to approximately 250 lb/in².

24. The duct of claim 23, wherein the insulated bonding sealer has a dynamic shear of approximately 80 lb/in².

25. The duct of claim 14, wherein the insulated bonding sealer resists mold growth.

26. The duct of claim 14, wherein the first and second locking portions form a snaplock, buttonlock, or hammerlock when attached to each other.

27. A method of manufacturing a duct from a sheet of flexible material having first and second parallel longitudinal edges defining a length of the duct, the method comprising the steps of:
attaching an insulated bonding sealer proximal the first longitudinal edge;
forming a first locking portion from the a sheet of material proximal the first longitudinal edge;
forming a second locking portion from the a sheet of material proximal the second longitudinal edge;
shaping the sheet of flexible material into a self-locking hollow enclosure;
attaching the insulated bonding sealer proximal the first longitudinal edge; and
engaging the first and second locking portions thereby forming a longitudinal seam substantially sealed by the insulated bonding sealer.

28. The method of claim 27, further comprising the step of attaching a second insulated bonding sealer proximal the second longitudinal edge.

29. The method of claim 27, wherein the insulated bonding sealer includes an adhesive layer covered by a removable tape liner, the step of engaging the first and second locking portions including the step of removing the tape liner from the insulated bonding sealer to expose the adhesive layer.
